(19) United States
(12) Patent Application Publication
(10) Pub. No.: US 2002/0167660 A1
(43) Pub. Date: Nov. 14, 2002

(54) Illumination for integrated circuit board inspection

(75) Inventor: Sergey Zaslavsky, Kiryat Yam (IL)

Correspondence Address: DR. MARK FRIEDMAN LTD., c/o ANTHONY CASTORINA, SUITE 207, 2001 JEFFERSON DAVIS HIGHWAY, ARLINGTON, VA, 22202, US

(73) Assignee: TESTSHIP AUTOMATIC TEST SOLUTIONS LTD.

(21) Appl. No.: 09/851,148

(22) Filed: May 9, 2001

(51) Int. Cl. G01N 21/00

(52) U.S. Cl. 356/237.2

(57) ABSTRACT

To overcome limitations of current optical inspection methods of integrated circuit boards, a new method of inspection is provided. A portion of the board being tested is illuminated at an oblique angle with a beam of coherent or collimated light. Furthermore three methods of detecting faults on integrated circuit board are presented, each which increases the utility of optical inspection of integrated circuit boards. The three methods are: 1) the use of diffraction of light to detect certain types of soldering faults: 2) the use of shadows to identify the presence or absence of components on an integrated circuit board: and 3) the direct illumination of components and parts of components. In addition, an innovative device for the illumination of integrated circuit boards is provided.

### FIELD AND BACKGROUND OF THE INVENTION

The present invention relates to the optical inspection of electronic assemblies and, more specifically, to improved methods and to an illumination device for optical inspection of integrated circuit boards.

Modern electronic devices are most often constructed by installing electronic components onto a printed circuit board (PCB). The first step in the production of such an electronic device is the manufacture of a PCB. Conductive channels or wires are printed onto a non-conductive substrate. The conductive channels connect points on the PCB to the edge connector of the PCB or connect between points and make the circuits of the PCB.

After the circuits are printed, the PCB is populated to give an ICB (Integrated Circuit Board). Passive components, such as resistors and capacitors, and active components, such as integrated circuits, are attached to the board so that the leads of the components make electrical contact with the proper points of the circuit. Once all the components have been installed in the proper place, the printed circuitry interconnects the components to form the ICB that is the required electronic device.

As in any complex manufacturing process various faults occur. After assembly, an ICB must be checked, and while being checked is referred to as a UUT (Unit Under Test).

One method known in the art to inspect the UUT is AOI (Automatic Optical Inspection). In AOI an optical imaging system is used to visually scan the UUT and, using computerized image processing techniques, the images found are compared to the expected UUT topography. Inspection includes seeking mounting errors to determine the presence or absence of electronic components, position deviation such as misalignment or tilting orientation and polarity markings on individual components are read to confirm that the correct component is in place at a given location. Connections are examined for bent leads and short circuits. Solder connections are checked for excess or insufficient solder and for the presence of solder bridges. By scanning the UUT it is confirmed that the circuitry is not damaged or short-circuited.

The increasing requirement for electronic devices with increasingly higher performance means that ICBs become compact and more densely populated while components become smaller and more complex. The more compact design of ICBs reduces the effectivity of contact diagnostic systems such as those based on flying probes or “bed of nails” adapters. As a result, there is a need for increasingly high speed and effective AOI.

U.S. Pat. No. 6,084,663, which is incorporated by reference for all purposes as if fully set forth herein, discloses an AOI system. Effective inspection of a UUT is performed using a plurality of color and monochrome cameras and a powerful illumination system to allow use of narrow camera apertures for image sharpness and good contrast. Some cameras are obliquely mounted to allow calculation of three-dimensional data. However, the device of U.S. Pat. No. 6,084,663 is large and cannot be easily combined with other inspection or diagnostic devices. The illumination system uses much energy and releases much heat.

U.S. Pat. Nos. 5,245,491 and 5,260,779 disclose a hemispherical lighting fixture containing hundreds of individually programmable LEDs that can be configured to achieve many combinations of lighting modes. Different combinations of lighting modes highlight different solder or assemble defects. However, this method has limitations. For example, the light intensity generated by LEDs is not usually bright. As a result the camera aperture must be open wide, limiting, the depth of the field of the imaging system. Furthermore, the detection algorithms are closely related to the specific lighting mode. As a result, programming of hundreds of LEDs is required for each new ICB inspected.

There is a need for improved methods for the optical inspection of compact and densely populated printed circuit boards.

### SUMMARY OF THE INVENTION

The above and other objectives are achieved by the illumination methods and the illumination device provided by the present invention.

According to the teachings of the present invention there is provided a method for inspecting a workpiece such as a ICB by illuminating the workpiece with a collimated or coherent light beam at an oblique angle and thereafter acquiring an image reflected from the workpiece. The angle is preferably between 1° and 80°, more preferably between 10° and 50°, and most preferably between 20° and 45° from perpendicular to the workpiece.

According to a further feature of the present invention, the angle is varied in order to improve the illumination. Preferably, the workpiece is isolated from other sources of light so that the only source of illumination of the workpiece is the illumination of the method of the present invention.

According to a further feature of the present invention, only a part of the workpiece is illuminated at any one moment.

There is also provided according to the teachings of the present invention a method for detecting hairline cracks at a location, such as a solder connection on a workpiece such as a ICB, by: a) directing a light beam at the location: b) acquiring an image of light reflected from the workpiece: and c) inspecting the image for a diffraction pattern. If there is a diffraction pattern or part (2 or 3 intense lines) of a diffraction pattern associated with the location, the presence of a hairline crack is indicated. Preferably, the only source of illumination of the workpiece is the illumination according to the present invention.

There is also provided according to the teachings of the present invention a method for examining a component installed on a workpiece such as a ICB, by: a) directing a light beam at an oblique angle at the location where the component is presumably attached to the workpiece; b) acquiring an image of light reflected from the workpiece; and c) inspecting the image for a shadow associated with or produced by the component. Failure to detect a shadow indicates that the component is missing. The angle is preferably between 1° and 80°, more preferably between 10° and 50°, and most preferably between 20° and 45° from perpendicular to the workpiece. The light beam is preferably collimated or coherent.

According to an additional feature of the present invention, the only source of illumination of the workpiece is the illumination according to the present invention. Preferably, the light beam only illuminates part of the workpiece, ideally only the presumed location of the component.

According to a further feature of the present invention, the shape of the shadow, if present, is analyzed. The presence of a deviant shaped shadow indicates that the component is installed incorrectly. According, to a still further feature of the present invention the angle is varied during inspection of a single location.

There is also provided according to the teachings of the present invention a method for the inspection of a workpiece such as a ICB, by: a) illuminating an area of the workpiece by directing a collimated light beam at an oblique angle at that area: and b) inspecting that area. The angle is preferably between 1° and 80°, more preferably between 10° and 50°, and most preferably between 20° and 45° from perpendicular to the workpiece. The light beam is preferably collimated or coherent. Preferably, the only source of illumination of the workpiece is the illumination according to the present invention.

According to a further feature of the present invention, the angle is varied during the inspection.

There is also provided according to the teachings of the present invention a device for illuminating an area on a plane (such as a UUT, for example a ICB) made up or: a) a light source, configured to produce a collimated light beam, or a coherent light source such as a diode laser; and b) a first mirror, mounted on a movable mount, the mirror positioned as to reflect the light beam towards the plane and the moveable mount configured to vary the distance between the light source and the first mirror and also configured to vary the angle of the first mirror relative to the light beam. It is preferable that the device includes an enclosure configured to isolate the plane from light other than that produced by the device itself.

According to a feature of the present invention the device includes a motorized mechanism for varying the distance and the angle, and preferably a control system for controlling the motorized mechanism.

According to a further feature of the present invention, the moveable mount and the first mirror is attached to an inspection device, such as a camera of an AOI system.

According to a still further feature of the present invention, the first mirror is mounted between the light source and the plane being illuminated.

According to a still further feature of the present inventions, the light beam exits the light source substantially perpendicular to the plane.

According to a still further feature of the present invention, the angle of the first mirror is varied about an axis parallel to the plane.

According to a still further feature of the present invention, the light source is made up of i) a primary light source (such as a diode laser) configured to emit the light beam: and ii) a second mirror positioned so as to reflect the light beam from the primary light source towards the first mirror. In this case, the light beam is preferably emitted from the primary light source substantially parallel to the plane and the second mirror is preferably positioned so as to reflect the light beam substantially perpendicular to the plane. In this case the second mirror is preferably is attached to an inspection device, such as a camera of an AOI system.

### BRIEF DESCRIPTION OF THE DRAWINGS

The invention is herein described, by way of example only, with reference to the accompanying drawings, where:

FIG. 1a is a schematic representation of the method of illumination of the present invention;

FIG. 1b is a schematic representation of specularly reflected light entering the observation system;

FIG. 2 is a schematic representation of a diffraction pattern formed as a result of a light beam passing through a hairline crack between a component lead and a solder bead;

FIG. 3a is a schematic top views of the area of illumination according to the invention where a component is missing;

FIG. 3b is a schematic top view of the area of illumination according to the invention when a component is present and casts a shadows;

FIG. 3c is a schematic top view of the area of illumination according to the invention when a component is present but mounted incorrectly, casting a deviant shadow;

FIG. 3d is a schematic side view of a capacitor casting a shadow;

FIG. 4 is a schematic drawing of an illumination device with one mirror, constructed in accordance with the teachings of the present invention; and

FIG. 5 is a schematic drawing of an illumination device with two mirrors, constructed in accordance with the teachings of the present invention.

### DETAILED DESCRIPTION OF THE INVENTION

The principles of the methods and operation of the illumination device according to the present invention are better understood with reference to the figures and the accompanying description. In the accompanying figures, like reference numerals refer to like parts throughout the figures.

Before turning to details of the present invention, it should be appreciated that the present invention provides a method of inspection and also provides three independent methods for detecting faults on an ICB, each which increases the utility of optical inspection of integrated circuit boards. The three methods for detecting faults are: 1) the use of diffraction of light to detect certain types of soldering faults: 2) the use of shadows to identify the presence or absence of components on an integrated circuit board; and 3) the direct illumination of components and parts of components in such a way as to eliminate shadows in order to increase the signal-to-noise ratio, to increase the depth of field and to increase the contrast of the images obtained.

Although each of the four methods may be performed using variety of devices, the innovative device of the present invention allows performance of all four methods.

In the following description and claims the terms collimated light is to be understood as a light beam wherein the rays of light making the beam are substantially parallel, such as a coherent light beam made by a laser or light that has passed through a collimator or an appropriate filter.

Method of Illumination

The method of illumination of the present invention relates to a method that provides for a high signal-to-noise ratio, a large depth of field and high contrast in the detected images. The method of illumination of the present invention eliminates strong reflections caused by shiny components and shadows that hide important features. These improvements simplify automatic identification of components and faults and lead to an increased utility of AOI methods. Further advantages of the present invention include that effective lighting is achieved using less energy and by producing less heat when compared to other illumination systems known in the art.

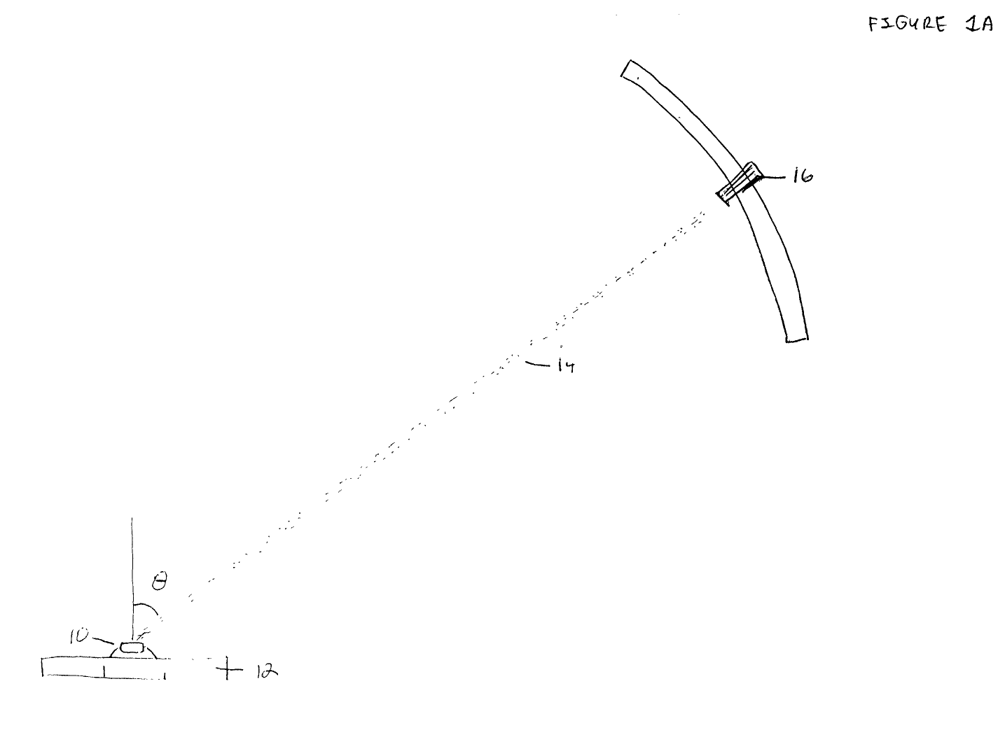

The method of illumination of the present invention, FIG. 1a, consists of locally illuminating a site of interest 10 on UUT 12 where light beam 14 is collimated. This is done, for example, using a coherent light source 16 or a properly designed non-coherent light source such as a lamp whose light is collimated.

Effective illumination of area of interest 10 is easily achieved with little expenditure of energy and release of heat since light beam 14 illuminates only a limited area. This leads to an increased depth of field with a concomitant increase of image sharpness. Since the rays of light beam 14 are collimated the signal-to-noise ratio of the detected image and the contrast in the image are increased relative to diffuse illumination methods.

Furthermore, illumination according to the teachings of the present invention consists of illuminating site of interest 10 with light beam 14 at a variable incident angle θ. Throughout illumination of UUT 12, θ is varied to achieve an optimal image, dependent on a number of constraints. First there are physical or engineering constraints that arise in a specific embodiment of the invention. Second, angle θ must be chosen to avoid specular reflection of the light 18 directly into the observation system 19, e.g. the camera or microscope lens. FIG. 1b. Variation of incident angle θ allows elimination of shadows or incidental reflections.

To apply the method of illumination of the present invention, it is necessary to provide a collimated light source and to illuminate the area of interest at a variable oblique incident angle. This is done using a coherent light source or a properly designed non-coherent light source. The angle of illumination is preferably between 1° and 80°. More preferably the angle is between 10° and 50°. Most preferably the angle is between 20° and 45°. One light source that can be used is the innovative illumination device of the present invention, described below.

It is clear to one skilled in the art that if the only source of illumination on UUT 12 during inspection is light beam 14 according to the method of the present invention the signal-to-noise ratio in the detected image is increased and contrast is optimized. Thus in a preferred embodiment of the method, substantially all other sources of illumination are eliminated.

Method of Inspection by Observation of Diffraction

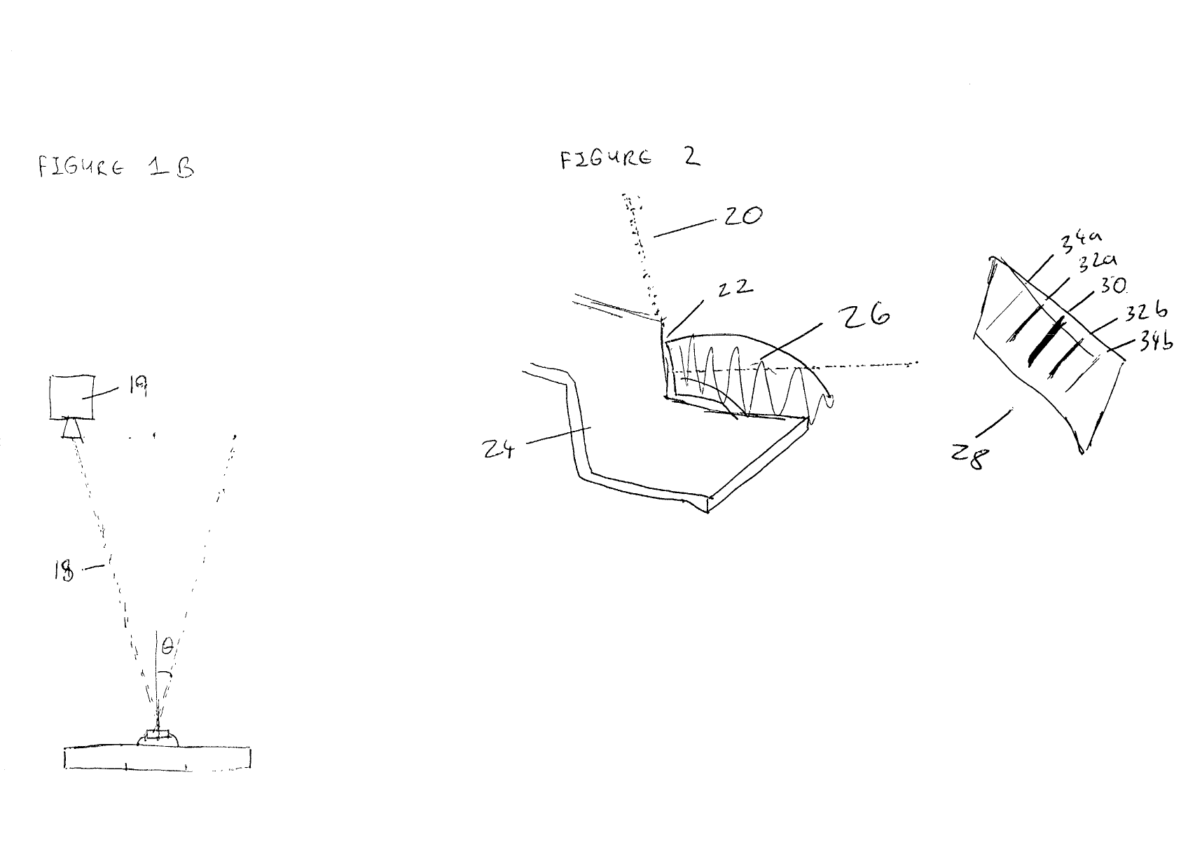

Mistakes made during the soldering of component leads to a PCB often lead to the information of hairline cracks between the solder bead and the component lead. Depicted in FIG. 2 is a collimated light beam 20 passing through a hairline crack 22 between component lead 24 and solder bead 26, forming a distinctive diffraction pattern 28. In FIG. 2, five lines of diffraction pattern 28 are shown. For diffraction patterns in general, a central line 30 has 70% of the energy of light beam 20 which passes through hairline crack 22, flanking lines 32a and 32b each 4.9% of the energy of light beam 20 which passes through hairline crack 22, and following flanking lines 34a and 43b each 0.34% of the energy of light beam 20 which passes through hairline crack 22. Observation of the distinctive diffraction pattern upon illumination of a solder bead indicates the presence of a hairline crack.

A diffraction pattern is always produced but is not detectable when the illumination methods known in the art are used. In order to eliminate shadows, increase contrast and to increase the depth of field, intense and diffuse illumination is used in the art. The diffuse light scatters in all directions and prevents detection of the necessarily dimmer diffraction pattern. It is thus not generally possible to detect even the brightest line in the diffraction pattern formed by a hairline crack, much less identify it as such.

The first method for detecting faults on all ICB according to the present invention is the identification of a soldering imperfection through the detection of a diffraction pattern formed at a component lead/solder bead interface.

Using an optical system with 256 shades of gray (corresponding to all 8 bit scale), where the intensity of the bright central line is assigned the value 256 (maximal brightness), then the value of the intensity of the flanking lines is 18 and the value of the intensity of the following flanking lines 1. Thus five lines are ordinarily detectable. Observation of the three brightest lines, or even of the brightest line and one of the flanking lines is sufficient to indicate the presence of a hairline crack.

Preferably, the ratio of intensity of the lines flanking the bright central line detected to identify detected light as a diffraction pattern is in the range of 15-21: 256. Preferably, the ratio of intensity of the following flanking, lines relative to the bright central line detected to identify detected light as a diffraction pattern is in the range of 1-3:256.

To apply this method, it is necessary to provide a light source of which the incident light rays are collimated. This is done, for example, using a coherent light source or a properly designed non-coherent light source. One light source that can be used is the innovative illumination device of the present invention, described below.

Method of Inspection by Observation of Shadows

As discussed above, components installed on ICBs are becoming increasingly smaller. For example, capacitors with a height of 600 microns, a width of 800 microns, and a length of 1700 microns are commonplace. The small size of some components means that when they are placed onto a PCB, they often fall off, disappear or shift from place before being permanently attached. As a result, it is important to visually confirm that all components are properly placed on an ICB. As is known to one skilled in the art, the color shade, shape and small size of some passive components are such that the optical examination technologies known in the art are often insufficient to confirm that the component is present or properly placed.

The second method according to the present invention of detecting faults on an ICB provides for the use of shadows to identify the presence or absence of components on a UUT. Accordingly, a collimated or coherent light beam is directed at an oblique angle at the location where the presence or absence of a component is to be confirmed. The angle of illumination is preferably between 1° and 80°. More preferably the angle is between 10° and 50°. Most preferably the angle is between 20° and 45°.

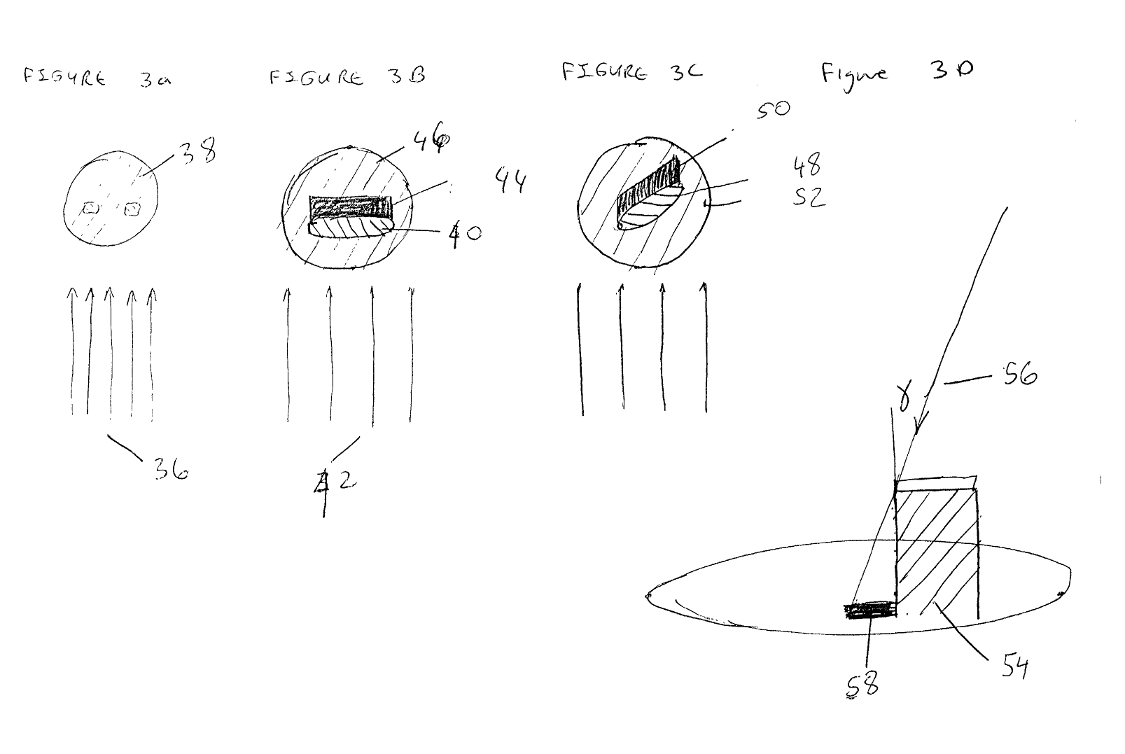

If the component is absent, FIG. 3a, then, since light beam 36 is collimated, illuminated area 38 is homogeneously bright with slight variations caused by the shading of the surface. No shadow is observed.

If a component 40 is present, FIG. 3b, the top of component 40 facing light beam 42 is illuminated. Component 40 casts a shadow 44 within illuminated area 46, on the side opposite light beam 42. Since light beam 42 is collimated, illuminated area 46 is homogeneously bright, excepting shadow 44, with slight variations caused by the shading of the surface and of the component. Due to the lack of any diffuse illumination light, shadow 44 is dark, clearly defined and easily recognizable as a shadow.

Furthermore, if component 48 is present (FIG. 3c) but has shifted to some extent from its nominal position, shadow 50 in illuminated area 52 has a deviant shape. By inspecting the shape of the shadow cast by a component according to the method of the present invention it is possible to confirm the presence and proper placement of components on an UUT.

The incident angle at which the light beam is projected at the suspected location of a component is dependent on various factors including the size of the expected component, the presence of other nearby components and parameters of the illumination and optical detection systems.

In a standard digital optical detection system used in AOI systems, 1 pixel is equivalent to 10 microns. In order to compensate for an error of ±1 pixel, a 4-pixel shadow is necessary, that is, a 40-micron shadow. In FIG. 3d, a 600-micron high capacitor 54 illuminated by light beam 56 with an incident angle γ of 10° casts a shadows 58 of 106 microns, that is 10 pixels.

To apply the second method of the present invention it is necessary to provide a light source that illuminates the component of interest at an oblique angle. Most preferably, the angle should be variable in order to optimize formation and detection of shadows. Furthermore, the light source should be the only light source, to eliminate scattered or diffuse light which blurs the shadow edges and lowers the shadow/illuminated area contrast. One light source that can be used to apply the second method of the present invention is the innovative illumination device of the present invention, described below.

Method of Inspection by Elimination of Shadows

Due to the presence of a large number of active and passive components of varying heights and sizes an ICB has a complex three-dimensional topography. The dense packing of components means that some components or parts of components are found in shadows cast by nearby structures and cannot be effectively examined using optical inspection systems. This is particularly true for the many small and closely spaced leads of some active components. The close spacing and small dimensions of the leads require that the image be optimal. Achieving an optimal image requires that the signal-to-noise ratio be high so diffuse illumination must be kept at a minimum. To maximize the depth of field, illumination intensity must be as high as possible. To increase contrast between the component leads, solder beads, and soldering pads, shadows must be eliminated. If the area being inspected is in a shadow or a partial-shadow cast, for example be the package of the attached active component, there may not be sufficient illumination for effective optical examination.

According to the third method of the present invention for detecting faults on an ICB, a collimated light beam is directed at an oblique angle at the area of interest. In such a way, shadows are eliminated and contrast and the signal-to-noise ratio are maximized. The bright illumination increases the depth of field giving maximal image sharpness.

The exact angle of illumination is dependent on UUT topology and takes into account nearby components that obstruct the line of sight between the light source and the area of interest. When using the third method of the present invention, the incident angle which gives the highest shadowless contrast in the field of view is determined. Illumination at this optimal incident angle allows effective inspection of components and circuitry and, in particular, inspection of the leads and solder beads of active components. The angle of illumination is preferably between 1° and 80°. More preferably the angle is between 10° and 50°. Most preferably the angle is between 20° and 45°.

To apply the third method of the present invention, it is necessary to provide a light source that illuminates the area of interest at an oblique angle. Most preferably, the angle should be variable in order to optimize formation and detection of shadows. Furthermore, the light source should be the only light source to eliminate scattered or diffuse light that casts partial shadows and reduces contrast as well as increasing the signal-to-noise ratio. One light source that can be used to apply the third method of the described below.

Illumination Device

The device of the present invention is an illumination device, useful for the inspection of ICBs.

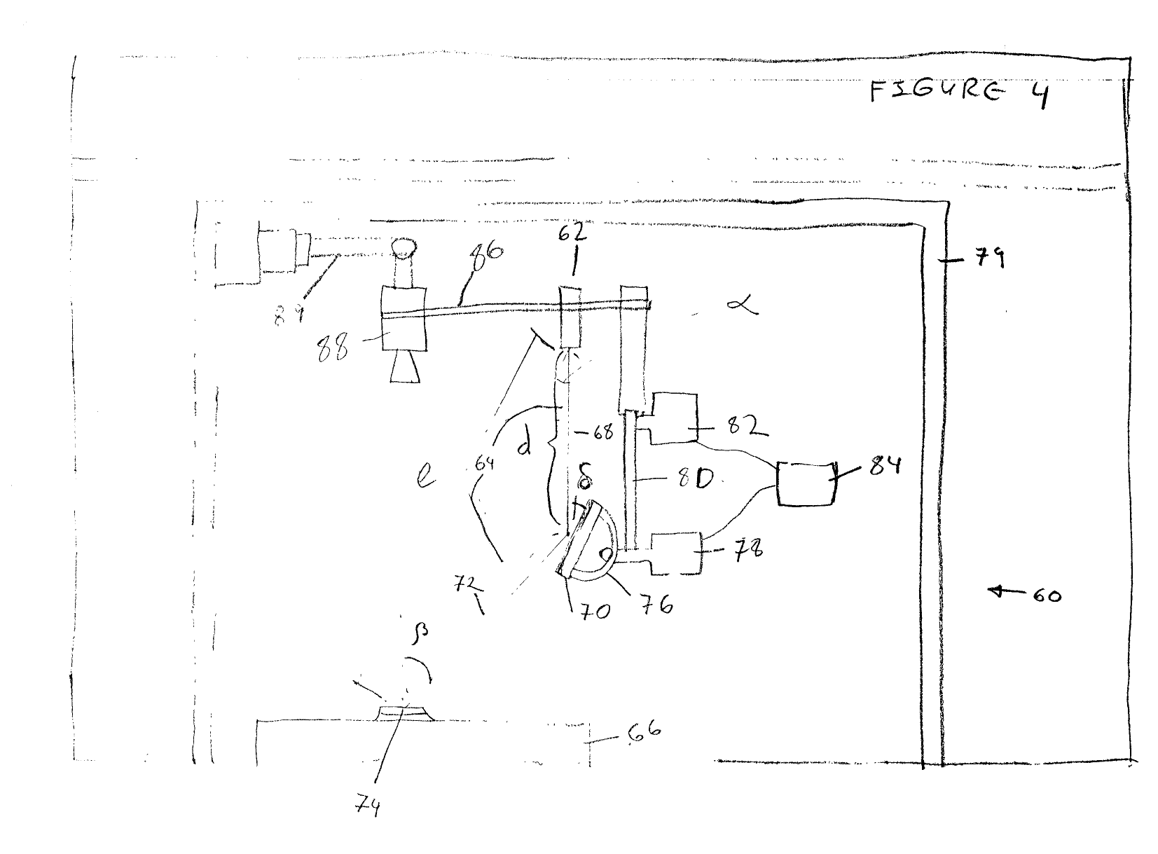

In one embodiment of an illumination device 60 of present invention, depicted in FIG. 4, a laser 62 produces a light beam 64. Laser 62 is mounted so that light beam 64 emerges substantially perpendicular to UUT 66. The first leg of travel 68 of light beam 64 is from laser 62 to a first mirror 70. First mirror 70 is mounted so that light beam 64 makes an angle δ with the reflective surface of first mirror 70. Light beam 64 is reflected and travels a second leg 72 until it illuminates a site of interest 74 on the surface of UUT 66 with an incident angle β. First mirror 70 is attached to a joint 76. Joint 76 is a hinge and is moved with the help of a first motor 78 and is configured to fix the angle of first mirror 70 relative to UUT 66 in a range from 0° to 90° on an axis substantially parallel to UUT 66. Joint 76 is attached to telescopic arm 80 which is extended and retracted perpendicular to UUT 66 with the help of a second motor 82 changing distance d between laser 62 and first mirror 70, distance d corresponding to the length of first leg 68. A control system 84 is configured to vary the angle δ of first mirror 70 and the length d by controlling first motor 78 and second motor 82 upon command in such a way that light beam 64 continuously illuminates site of interest 74, although incident angle β changes. In FIG. 4 laser 62 is mounted so that the angle α from site of interest 74 to laser 62 to first mirror 70 is fixed. Laser 62 is also mounted so that the distance/from laser 62 to site of interest 74 is constant. The relationship, maintained by control system 84, between the length d of first leg 68 to the angle of incidence β of light beam 64 is given by:

$$tan β = \frac{d sin ( α )}{l - d cos ( α )}$$

where l is the fixed distance from laser 62 to site of interest 74. d is the variable distance from laser 62 to first mirror 70, α is the fixed angle defined by the points site of interest 74, laser 62, and first mirror 70, and β is the variable angle of incidence from perpendicular of light beam 64 at site of interest 74.

In the embodiment of the device of the present invention depicted in FIG. 4 some of the physical elements, namely laser 62, first mirror 70, joint 76, first motor 78, telescopic arm 80 and second motor 82 of the device are mounted on a bracket 86 connected to a camera 88. Camera 88 is attached to robotic arm 89 that is configured to move camera 88 to scan UUT 66. The elements of the device of the present invention which are connected through bracket 86 to camera 88 travel with camera 88 as it scans UUT 66. In such a way, site of interest 74 illuminated by the device is always observable by camera 88.

In order to eliminate all sources of illumination excepting the illumination from the device of the present invention and in such a way increasing contrast and increasing signal-to-noise, UUT 66, camera 88 and illumination device 60 are contained within enclosure 79.

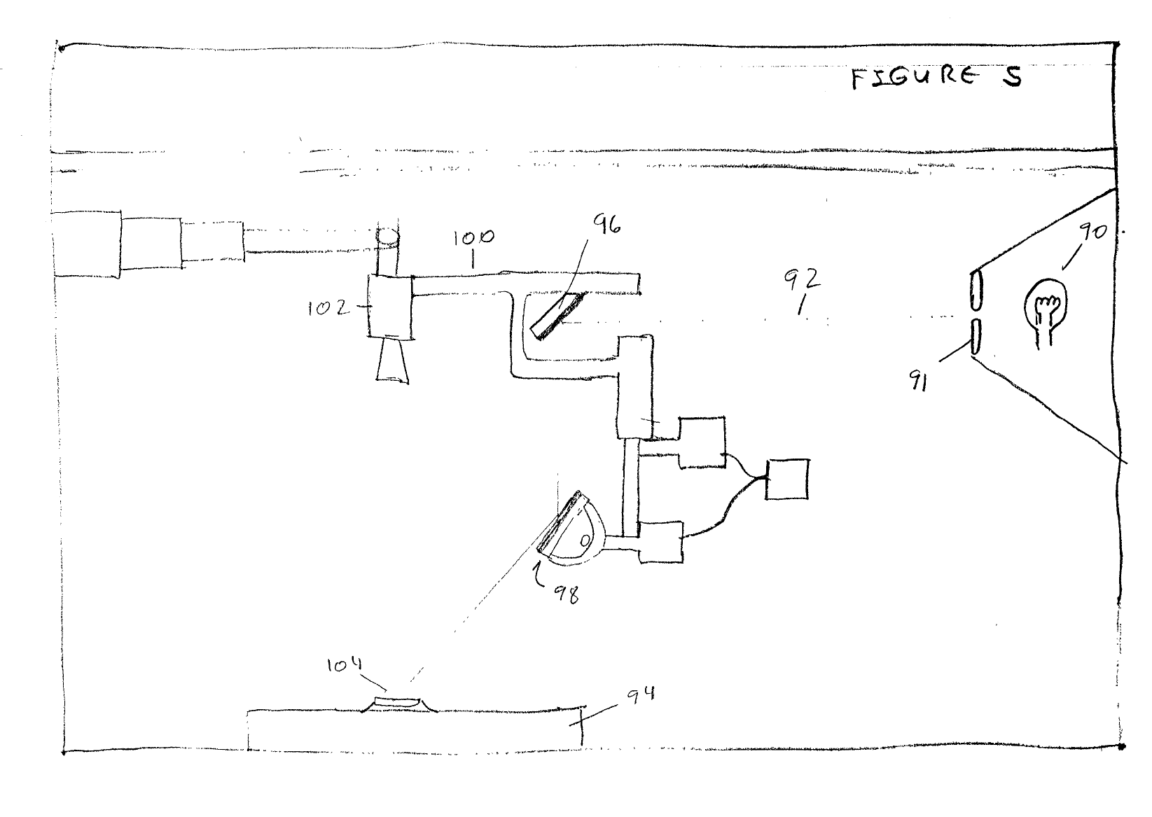

In another embodiment of the illumination device of present invention, depicted in FIG. 5, light beam 92 is produced by light emitted by light source 90 passing through a collimating device 91. Light beam 92 travels substantially parallel to UUT 94 and strikes the reflective surface of a second mirror 96. Second mirror 96 is mounted at an angle relative to light beam 92, in the embodiment depicted in FIG. 5 the angle being 45°, in such a way that light beam 92 is reflected towards first mirror 98 and perpendicularly to UUT 94. The manner of usage and operation of the illumination device in FIG. 5 is, in analogy to the illumination device depicted in FIG. 4, apparent to one skilled in the art. Accordingly, no further discussion relating to the manner of usage and operation is provided.

Since light beam 92 initially emerges from collimating device 91 parallel to UUT 94, diffuse and scattered light does not illuminate UUT 94.

The illumination device of the present invention is useful for the illumination of an ICB for optical inspection or for automatic optical inspection. In addition, the illumination device of the present invention is useful for implementing the four methods of the present invention, as described above.

Furthermore, the illumination device of the present invention is compact and lightweight. It is a simple matter for one skilled in the art to integrate the illumination device of the present invention with other types of PCB diagnostic systems such as X-ray examination or flying probe systems. Such integration can be performed with few, if any, negative effects by mounting the illumination device along with a optical device such as a camera on a moveable arm.

For all embodiments of the methods and the illumination device of the present invention many light sources can be used, the only requirement being that the light rays of the beam that illuminates the site of interest are substantially parallel and that scattering of light is minimized. In the embodiment of the invention depicted in FIG. 5, a non-coherent light source whose light has been collimated to reflect off of a could mirror is used. More preferably, a coherent light source, such as a red or green diode laser, is used as in the embodiment of the invention depicted in FIG. 4. Diode lasers are cheap, release little heat and use little energy.

The teachings of the present invention can be applied to manly different workpieces but the primary intended application as described herein concerns the inspection of PCBs. However, it is clear to one skilled in the art that the present invention is not limited to the embodiments described herein but also relates to all kinds of modifications thereof, insofar as they are within the scope of the claims.

What is claimed is:

1. A method for inspecting an workpiece comprising:
a. illuminating the workpiece with a collimated light beam at an oblique angle: and
b. acquiring an image of light reflected from the workpiece as a consequence of said illuminating.

2. The method of claim 1 further comprising:
c. varying said oblique angle.

3. The method of claim 1 wherein the workpiece is substantially illuminated only by said collimated light beam.

4. The method of claim 1 wherein said angle is between 1° and 80° from perpendicular to the workpiece.

5. The method of claim 4 wherein said angle is between 10° and 50° from perpendicular to the workpiece.

6. The method of claim 5 wherein said angle is between 20° and 45° from perpendicular to the workpiece.

7. The method of claim 1 wherein said light beam illuminates only a part of the workpiece.

8. The method of claim 1 wherein said light became is coherent.

9. A method for detecting hairline cracks at a location on a workpiece comprising:
a. directing a light beam at the location:
b. acquiring an image of light reflected from the workpiece; and
c. inspecting said image for a diffraction pattern associated with the location.

10. The method of claim 9 wherein the workpiece is substantially illuminated only by said light beam.

11. The method of claim 9 where said diffraction pattern comprises at least a first detected light and a second detected light, where a ratio of intensity between said first detected light and second detected light is between 256:15-21.

12. The method of claim 9 where said diffraction pattern comprises at least a first detected light, a second detected light and a third detected light, said first detected light is flanked by said second detected light and said third detected light and where a ratio of intensity between said first detected light and said second detected light is between 256:15-21 and where a ratio of intensity between said first detected light and said third detected light is between 256:15-21.

13. The method of claim 9 where said diffraction pattern comprises at least a first detected light, a second detected light, a third detected light, a fourth detected light and a fifth detected light,
and second detected light is flanked by said fourth detected light and said first detected light,
said first detected light is flanked by said second detected light and said third detected light,
said third detected light is flanked by said first detected light and said fifth detected light,
and where
a ratio of intensity between said fourth detected light and said first detected light is between 1-3:256,
a ratio of intensity between said second detected light and said first detected light is between 15-21:256,
a ratio of intensity between said first detected light and said third detected light is between 256:15-21, and
a ratio of intensity between said first detected light and said fifth detected light is between 256:1-3.

14. A method for examining a component installed on a workpiece comprising:
a. directing a light beam at an oblique angle at a suspected location of the component attached to the workpiece;
b. acquiring an image of light reflected from the workpiece; and
c. inspecting said image for a shadow associated with the component.

15. The method of claim 14 wherein said angle is between 1° and 80° from perpendicular to the workpiece.

16. The method of claim 15 wherein said angle is between 10° and 50 ° from perpendicular to the workpiece.

17. The method of claim 16 wherein said angle is between 20° and 45° from perpendicular to the workpiece.

18. The method of claim 14 further comprising:
d. varying said angle.

19. The method of claim 14 further comprising:
d. analyzing a shape of said shadow.

20. The method of claim 14 wherein the workpiece is substantially illuminated only by said light beam.

21. The method of claim 15 wherein said light beam illuminates only a part of the workpiece.

22. The method of claim 14 wherein said light beam is collimated.

23. The method of claim 14 wherein said light beam is coherent.

24. A method for the inspection of a workpiece comprising:
a. illuminating an area of the workpiece to directing a collimated light beam at an oblique angle at said area of the workpiece; and
b. inspecting said area.

25. The method of claim 24 further comprising:
c. varying said angle.

26. The method of claim 24 wherein inspecting said area includes acquiring an image of light reflected from the workpiece as a consequence of said illuminating.

27. The method of claim 24 wherein the workpiece is substantially illuminated only by said light beam.

28. The method of claim 24 wherein said angle is between 1° and 80° from perpendicular to the workpiece.

29. The method of claim 28 wherein said angle is between 10° and 50° from perpendicular to the workpiece.

30. The method of claim 29 wherein said angle is 20° and 45° from perpendicular to the workpiece.

31. The method of claim 24 wherein said light beam is coherent.

32. A device for illuminating an area on a plane comprising:
a. a light source, configured to produce a collimated light beam, and
b. a first mirror with a first reflective surface, mounted on a moveable mount, said reflective surface positioned as to reflect said light beam towards the plane and said moveable mount configured to vary a distance between said light source and said first mirror and configured to vary an angle of said first mirror relative to said light beam.

33. The device of claim 32 further comprising a motorized mechanism for varying said distance and for varying said angle.

34. The device of claim 33 further comprising a control system for varying said motorized mechanism.

35. The device of claim 32 wherein said moveable mount is attached to an inspection device.

36. The device of claim 35 wherein said inspection device includes a camera.

37. The device of claim 32 wherein said first mirror is mounted between said light source and the plane.

38. The device of claim 32 where said light beam exits said light source substantially perpendicular to the plane.

39. The device of claim 32 where said angle of said first mirror is varied about an axis parallel to said plane.

40. The device of claim 32 wherein said light beam is coherent.

41. The device of claim 32 wherein said light source is a diode laser.

42. The device of claim 32 wherein said light source includes:
i. a primary light source configured to emit said light beam; and
ii. second mirror with a second reflective surface, said second reflective surface positioned so as to reflect said light beam from said primary light source towards said first mirror.

43. The device of claim 42 wherein said light beam is emitted from said primary light source substantially parallel to the plane.

44. The device of claim 42 wherein said second reflective surface is positioned so as to reflect said light beam substantially perpendicular to the plane.

45. The device of claim 42 wherein said second mirror is attached to an inspection device.

46. The device of claim 42 wherein said primary light source is a diode laser.

47. The device of claim 32 further comprising an enclosure configured to substantially isolate the plane from sources of illumination excepting light reflected from said first mirror.
